(19) United States
(12) Patent Application Publication
(10) Pub. No.: US 2023/0000112 A1
(43) Pub. Date: Jan. 5, 2023

(54) DOG TREAT COMPOSITION AND METHOD OF PREPARATION

(71) Applicant: Stan Egaas, Clatskanie, OR (US)

(72) Inventor: Stan Egaas, Clatskanie, OR (US)

(21) Appl. No.: 17/367,035

(22) Filed: Jul. 2, 2021

(51) Int. Cl. A23K 40/20; A23K 10/20; A23K 10/30; A23K 30/20; A23K 50/42

(52) U.S. Cl. CPC A23K 40/20; A23K 10/20; A23K 10/30; A23K 30/20; A23K 50/42; A01K 15/026

(57) ABSTRACT

A composition of organic materials includes an organ-based animal meat reduced to a pulp, a binder, and a percentage of liquid to enable creation of a homogeneous mixture with a viscosity similar to a batter upon blending the organic materials together. The mixture is poured into a waffle form and cooked, then cooled, freeze dried, and vacuum sealed into an individual pouch.

### CROSS-REFERENCE TO RELATED DOCUMENTS

[NA]

### BACKGROUND OF THE INVENTION

### 1. Field of the Invention

The present invention is in the field of pet food as a treat preparation and pertains particularly to methods and apparatus for mixing and preparing a dog treat composition.

### 2. Discussion of the State of the Art

In the field of food preparation, there are many products that are meat-based that are commercially marketed as animal foods or treats. For example, freeze dried dog foods often contain meat-based products including lamb, turkey, duck, salmon, beef, and chicken along with bone meal and other components including preservatives, grains, vitamins, and other beneficial additives that may be deemed generally suitable for consumption by most dog breeds. Dog treats may be provided as dry dog treats, as wet dog food or as dog food or treat containing a percentage of moisture. In addition to stable dietary products like dog food and treats, there are many products or compositions that are not marketed as a stable dog food but more as a dog treat that may take the form of a freeze-dried product like dog biscuits, dog jerkies, dog chews, dog bones, and dried skins (dried pork skins), etc.

While there are many different meats tapped for inclusion into dog food and dog treats in a general sense, often the percentage of meats to other non-nutritional binders and grain fillers is paltry enabling the compositions to be marketed cheaper. While a wide variety of meat-based products are marketed in the industry, products that include liver or other organ-based meats: animal hearts, kidney, or brains are not as prevalent in dog foods or treats as stock meats listed further above. One reason liver is a sought-after ingredient in dog food and dog treat manufacture is that it is relatively inexpensive but provides packed amounts of proteins, fats, vitamins, amino acids, and essential minerals that provide health benefit for the dog.

While animal liver is considered safe and beneficial for dogs in general, care should be given to the frequency and amount of liver the dog receives. It is possible that too much liver in a dog's diet may overload the dog with too much vitamin A, which can be unhealthy at doses that the dog may not be able to process efficiently. Raw liver or other organ meats that are not cooked but are freeze-dried to preserve shelf life of the product can harbor bacterium like listeria or salmonella that was in the raw meat and may be preserved along with the product when freeze-dried. Another challenge with some baked products is that overcooking can reduce or eliminate some of the nutrients like vitamins and amino acids for example. A further challenge is producing a form of treat that does not crumble or break apart being too dry or not bound well with a suitable binder. Still a further challenge is packaging. Dog food or dog treats that are packaged together in one box or bag may invite contaminants including mold, bacterium, chemicals, pests, etc.

Therefore, what is clearly needed is a dog treat composition that is free of bacterium, holds together well, has a superior shelf life, and is compartmentalized into individual packaged servings so that it is not contaminated by open box or bag packaging that may allow moisture and contaminants to compromise the nutritional value of the product.

### BRIEF SUMMARY OF THE INVENTION

According to an embodiment of the present invention, a composition of organ-based animal meat is reduced to a pulp, a grain free binder in some embodiments, and a percentage of liquid to enable creation of a homogeneous mixture with a viscosity similar to a batter upon blending the meat materials together. In a preferred embodiment, the organ-based meat is animal liver. In a variation of this embodiment, the animal liver is lamb liver, turkey liver, chicken liver, or any combination thereof In another embodiment, the organ-based meat is heart, kidney, brain, or any combination thereof.

In one embodiment, the binder is flour or a combination of more than one flour type. In a variation of this embodiment, the flour is arrowroot flour, potato flour, tapioca flour, soy flour, or an7y combination thereof. In an alternate embodiment, the binder is milk powder, soy powder, or any combination thereof. In a preferred embodiment, the homogeneous mixture is created using a blender apparatus. In one embodiment, the composition may further include a ground animal muscle meat like ground beef, ground chicken, ground turkey, ground lamb, or any combination thereof.

According to an embodiment of the present invention, a method for preparing a dog treat composition for consumption is provided, the dog treat composition including at least one organ-based animal meat, a grain-free binder, and a percentage of liquid to enable creation of a homogeneous mixture with a viscosity similar to a batter upon blending the organic materials together, the method including (a) chopping, pulverizing, or otherwise reducing the meat to a pulp, (b) adding the meat pulp, the grain-free binder, if using, and a percentage of liquid to a blender apparatus, (c) blending the mixture together to form a homogeneous batter, (d) filling a waffle iron form with the homogeneous batter, (e) cooking the homogeneous batter in the waffle iron form for a time period at a preset temperature, (f) removing the cooked waffle-formed product from the waffle iron and allowing it to cool, (g) placing the cooked waffle formed product into a freeze-dryer apparatus, and (h) freeze-drying the cooked waffle formed product to reduce moisture to 10 percent of volume or below.

In one aspect of the method, in (a) the organ-based animal meat is an organic lamb liver, an organic chicken liver, an organic turkey liver, or any combination thereof In another aspect, (a) the organ-based animal meat is heart, kidney, brain, or any combination thereof In one aspect, in (b) the grain-free binder is flour or any combination of more than one flour. In a variation of this aspect, the flour is arrowroot flour, potato flour, tapioca flour, soy flour, or any combination thereof.

In one aspect of the method, in (b) the percentage of meat pulp is about 65 percent of total volume, the percentage of binder is about 27 percent of the total volume, and the percentage of liquid is about 8% of the total volume. In one aspect, in (d) filling the waffle iron form with the batter is automated by machine process. In one aspect, in (e) the cooking time is about 5 minutes at 355 to 375 degrees Fahrenheit. in one aspect, in (e) the amount of batter poured into a waffle form is about one-half of a cup of batter. In one aspect, in (f) the waffle form is about 3 ½ inches long, about 2 ½ inches wide, and about ⅝ inches deep. In one aspect, in (h) the waffle form is reduced in moisture content to 1 to 5 percent by volume.

### BRIEF DESCRIPTION OF THE SEVERAL VIEWS OF THE DRAWINGS

FIG. 1A is an overhead view of a dog treat waffle form according to an embodiment of the present invention.

FIG. 1B is an end view of the dog treat waffle form of FIG. 1.

FIG. 1C is an end view of a dog treat waffle form according to an alternate embodiment of the present invention.

FIG. 2 is a process flow chart depicting steps for preparing a dog treat waffle form for consumption.

### DETAILED DESCRIPTION OF THE INVENTION

In various embodiments described in enabling detail herein, the inventor provides a unique dog food composition in the form of a treat and method of preparation thereof for consumption. It is a goal of the present invention to provide a nutritious dog treat in a presentation form that is resistant to crumbling or otherwise losing form. It is also a goal of the present invention to provide a dog treat that is safe from bacterium, mold, pests, and other contaminates. It is a further goal of the invention to shorten the length of drying time and cooking time for meat-based dog food products. One more goal is to provide an efficient space-saving design for shipping and storing with stackable and interlocking dog biscuit shapes. The present invention is described using the following examples, which may describe more than one relevant embodiment falling within the scope of the invention.

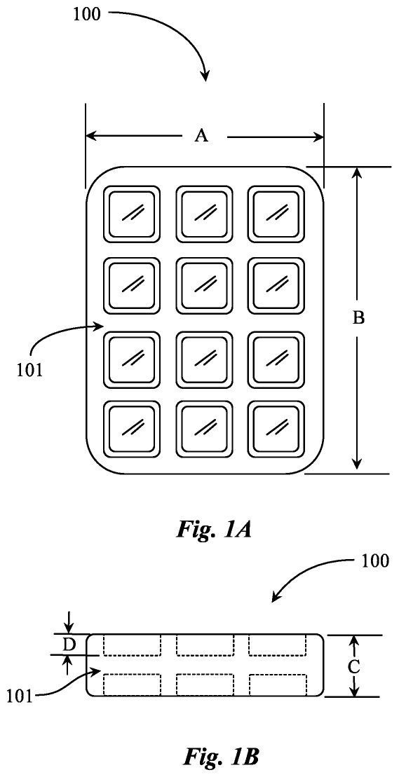

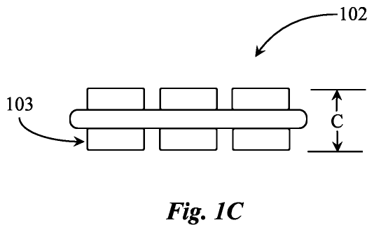

FIG. 1A is an overhead view of a dog treat waffle form 100 according to an embodiment of the present invention. Waffle form 100 may be a composition of meat, a binder, and a liquid formed into a batter that may be poured into a waffle-iron mold plate and cooked to set the form. Waffle form 100 is, in a preferred embodiment, a dog treat that is further treated in a freeze-drying process to reduce moisture content to preserve shelf life (freshness) of the treat. Waffle form 100 may have a dry weight after freeze-drying of about three-quarters of an ounce representing a single serving as a treat for a dog. It is noted, however, that larger or smaller waffle forms may be provided for different dog breeds of varying sizes without departing from the spirit and scope of the invention. Dog treat waffle form 100 may be a molded product cooked in a waffle iron or baked in a waffle mold. Waffle pattern 101 is evident in this view and comprises a symmetrical arrangement of square indents on both sides of dog treat 100.

Dog treat waffle form 100 in this embodiment has a width dimension A of about 2 and one-half inches, and a length dimension B of about 3 and one-half inches; other embodiments may be created by increasing or decreasing the length and/or width of waffle form 100 and/or increasing or decreasing the number of indented squares in waffle pattern 101. Dog treat 100 may include an organic animal organ meat such as liver, kidney, heart, or brain, of a combination thereof as a major ingredient in the composition of the present invention. In one embodiment, organic liver is the only meat in the composition. In this embodiment, liver may make up about sixty-five percent of volume of the total weight of the product. Also, in a variation of this embodiment, lamb liver, turkey liver, or chicken liver or a combination thereof may comprise the liver meat used in the dog treat waffle form 100. In a further variation of the embodiment, liver may be combined with another organic meat like an animal muscle meat including ground beef, ground turkey, ground lamb, ground chicken, or any combination thereof, wherein the combined meat ingredient equals approximately 65 percent of the total weight by volume of the composition, which in this example is about three-quarter of ounce (post preparation).

In a preferred embodiment, dog treat waffle form 100 may include a binder in the form of a flour type like arrowroot, potato flour, tapioca flour, milk powder, soy flour. In one embodiment, a grain free binder is used. In another embodiment, the flour may be white flour or wheat flower. The binder may make up about 27% of the total volume of the composition. A liquid like water, for example, may make up about 8% of the total volume of the composition. Other liquids may be considered such as chicken, beef, turkey, or lamb broths. In a variation of this embodiment, a broth may include an organic aid for the dog like a glucosamine, turmeric, or other organic powder that may help with joint comfort or inflammation in general. A liquid component percentage may be as low as 6% of the total volume of the composition.

In a preferred embodiment, the waffle form 100 does not include a binder and includes only meat and water. The meat may be pre-prepared into a pulp or finely chopped or pulverized state for addition to an electric mixing or blending apparatus. A goal of mixing the composition is that it be blended into a thick batter that is viscous but may be poured, squirted, or otherwise easily introduced into a waffle cooking apparatus like a waffle iron or a waffle mold form. Blending or mixing may be accomplished with electric apparatus like a commercial blender, or with electric mixing tools operated within a vessel containing the ingredients of the composition of the invention. In a preferred embodiment, the thick batter should be a homogeneous mixture (fine uniformly distributed and suspended ingredients).

FIG. 1B is an end view of dog treat waffle form 100 of FIG. 1. Dog treat waffle form 100 has a thickness dimension C of about five eighths of an inch. Waffle iron pattern 101 produces an indent pattern depicted herein by broken boundary. In a preferred embodiment, a waffle iron pattern like pattern 101 produces a form that is less likely to crack, crumble, or otherwise become compromised in form due to packaging and handling. Another utility benefit of using a waffle iron pattern 101 is that a waffle pattern creates more surface area for the cooked dog treat 100. Having more surface area contributes to a shorter period of time for freeze-drying the product during the vacuum phase of the freeze dry process. Waffle pattern 101 is produced by a raised pattern of symmetrically arranged square forms; however, other symmetrical waffle iron patterns having a different geometric shape may be utilized without departing from the spirit and scope of the present invention.

A particular advantage of using waffle forms in the preparation of a dog treat, like waffle form 100 is that the indentions provide four additional walls and a floor in each the indentions which exponentially increases surface area for more efficient processing during cooking in the waffle irons and in the freeze drying process.

FIG. 1C is an end view of a dog treat waffle form 102 according to an alternate embodiment of the present invention. Dog treat waffle form 102 may be created by a waffle iron pattern that is an inverse pattern from the pattern used to create dog treat waffle form 100 wherein a waffle pattern 103 creates a raised form and the substrate is thinner. In this alternate embodiment, the thickness dimension C of about ⅝ inches is the same as are dimensions A and B depicted in FIG. 1A for dog treat waffle form 100. A raised form also produces a more physically resilient form less likely to crack, crumble, or otherwise become deformed of compromised during packaging and handling as well as creating more surface area for vacuum sublimation or reduction of moisture content in the product during the freeze dry process. An added benefit in raised waffle pattern 103 is that the product is more easily devisable by breaking it along a selected line of the waffle pattern 103. It is also noted herein that both waffle forms 100 and 102 require less cooking time compared to a uniformly thick dog treat product by increasing the iron to batter surface area. In one embodiment, the waffle iron or waffle mold forms are treated with a non-stick surface so that the cooked product is easily removed from the waffle forms or waffle iron plates. In one embodiment, a small amount of vegetable oil may be mixed into the batter to help prevent the product from sticking to the waffle iron surfaces or waffle mold surfaces. In another embodiment, the square indentations in waffle pattern 101 may interlock with the protruding squares in waffle pattern 103 to provide a space saving stack of alternating waffle forms 100 and waffle forms 102.

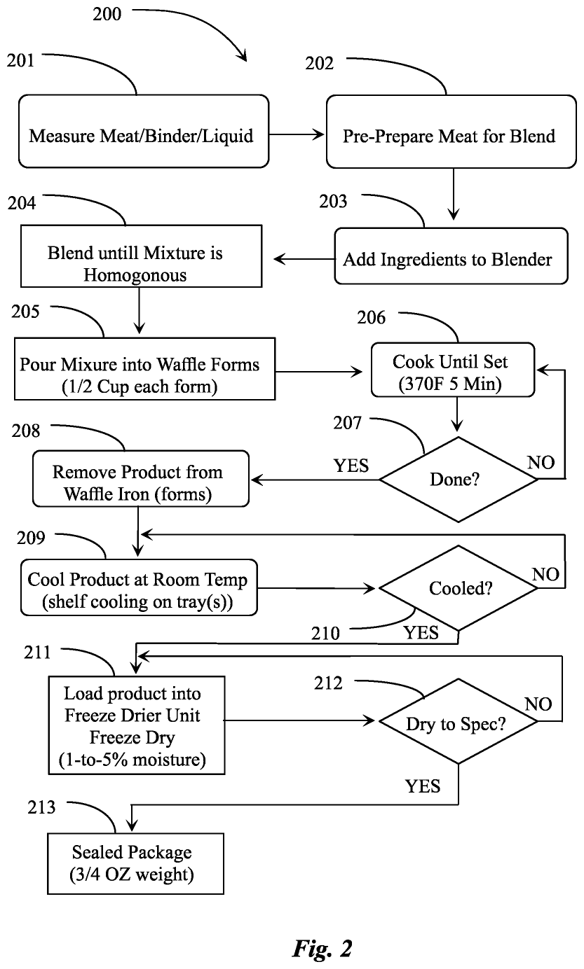

FIG. 2 is a process flow chart 200 depicting steps for preparing a dog treat waffle form for consumption. At step 201, an operator making dog treat waffle forms 101 or 102 from FIG. 1 may measure out the amount of organic meat, binder, and liquid by percentage that will be introduced to make a uniform batter. At step 202, the operator may pre-prepare the organic meat for addition to the process. The actual process may be contingent upon the original form the meat before processing. For example, meat may be solid slabs that must be chopped, ground, or otherwise pulverized or mashed into a meat pulp before mixing with binder, water, or other liquid. It is also noted herein that organic meat may already be ground or already be reduced to a paste or pulp before use. Liverwurst is a product that may already be a paste before it is used, for example.

At step 203, the operator may add the measured amount of meat, binder, water, or other liquid into an electric blender. At step 204, the operator may blend the ingredients until a relatively thick homogeneous batter is formed. This operation may be scaled up or down as required as long as the percentage of ingredients is stable according to percentage by volume of organic meat, binder, and water. In a preferred embodiment, the batter is used as soon as it is produced so that it does not settle or become a heterogeneous mixture. In one embodiment, batter may be created and frozen to be used at a later time. In a preferred embodiment it is used while freshly created and blended.

At step 205, the operator may pour batter mixture onto a waffle iron or into waffle forms at one half cup of batter per form. This process may be a manual process, a semi-automated process, or a wholly automated process depending upon the environment of use, for example, commercially created verses consumer created. In an embodiment using a waffle iron, an amount of batter may be poured or otherwise injected into a waffle iron or waffle mold form whereby the cooked material is a large sheet cut into individual forms after it is cooked or to the dimensions representing an individual dog treat like dog treat 100. At step 206, the batter may be allowed to cook at a temperature of about 370 degrees Fahrenheit for about five minutes. An acceptable temperature range window for cooking might be from about 355 degrees to about 375 degrees with 370 representing a nominal number.

At step 207, a process decision may be executed to determine when the batter is sufficiently cooked. For example, a visual or inner temperature indication that the batter is cooked sufficiently may be provided on the cooking apparatus via adding a light emitting diode (LED) indicator. If a determination is made at step 207 that the cooking cycle is not done or complete, the process resolves back to step 206. If at step 207, the determination is that the cooking cycle is done, the process moves to step 208 and the operator or mechanical automated process may remove the cooked product from the waffle iron or waffle mold(s). In one embodiment, a step may be added for cutting the sheets to the required length and width dimensions to produce individual dog treats.

At step 209, the operator or mechanical automated process may place the product before cutting, after cutting, or as individually cooked forms onto one or more cooling trays so the product may cool down to around room temperature. Cooling to room temperature aids in the product setting and holding form. At step 210, it may be determined by an operator or automated process if the shelved product is cooled down to the desired temperature. In one embodiment, a temperature sensor may be used to determine when the product is cooled down to a desired temperature whereby an indicator LED may inform when the product has reached the desired temperature. If at step 210, the cooked product has not yet cooled sufficiently, the process may revert back to step 209 for added cooling time. If at step 210 it is determined that the product has cooled sufficiently, the operator or automated process may load the product into a commercial freeze dryer at step 211.

It is noted herein that the amount of moisture in the cooked product may be higher than 10 percent moisture by volume. The goal of freeze drying is to further reduce the amount of moisture in the product to as low as 1 to 5 percent moisture by volume. The freeze dry process is well known in the art and removes moisture from a product in three phases. The first stage is freezing the product below the triple point of the material so that the second phase, referred to herein as the primary drying phase (sublimation), may occur. Temperatures may be as low as between −30 degrees and −85 degrees F. (preferably about −65 F degrees). The third stage is a secondary drying phase or the absorption phase. The goal is to achieve a dried product having 5% or less moisture content by volume.

At step 212, it may be determined if the product is successfully dried to the desired moisture content of below 10%. In one embodiment, it may be acceptable to have as much as 10% or more moisture content in the product. However, lower moisture content helps to preserve the product for longer periods of time. If at step 212, the determination is that the product is not sufficiently dried, the process reverts back to the freeze-dry process at step 211. If the determination is that the product is sufficiently dry at step 212, then the product portions may be individually packaged at step 213 via an envelope type package or vacuum packaging machine operated by an operator or by automated process. In one embodiment, the individual dog treats may be placed in an envelope type package with a seal along the length and then sealing both ends. Another embodiment may provide a shrink wrap. In another embodiment, the individual dog treats may be placed into polymer bags, nitrogen sealed, or vacuum/heat sealed by an operator using a conventional vacuum packaging machine or a shrink wrap machine, or by automated robotic process if commercial scale. Also, if stackable option is chosen, the treats would be stacked between steps 212 and 213. It is noted herein that cutting a sheet into individual forms may be a last step before packaging.

In one embodiment, individual dog treats may be individually packaged and put in a box or carton containing multiple packaged dog treats. In another embodiment, individual dog treats may be collectively placed in a larger poly bag and vacuum sealed therein. Individual packaging is preferred in this embodiment so that product is not exposed to the general environment long before use of the product. Shelf life for individual dog treats may be longer than six months and up to three years. Another utility benefit of using a waffle pattern in the individual dog treats is that an operator may use the offset of the waffle pattern to hold secondary substances like spread peanut butter, wet food, etc.

It will be apparent to the skilled person that the arrangement of elements and functionality for the invention is described in different embodiments in which each is exemplary of an implementation of the invention. These exemplary descriptions do not preclude other implementations and use cases not described in detail. The uses and methods depicted within this description are purely emblematic of definitive ways in which to build and operate this invention and are not to be understood to be limiting of scope in any way. While the uses and methods have been described with a certain degree of particularity, it is to be noted that many alterations could be made in the details of the construction and the arrangement of the apparatus and its components without departing from the spirit and scope of this invention. It is implied that the uses and methods are not limited to the examples represented in this specification for the purpose of clarification and persuasion. The invention is limited only by the breadth of the claims below.

1. A composition and form of organic materials comprising:
an organ-based animal meat reduced to a pulp; and
a percentage of liquid to enable creation of a homogeneous mixture with a viscosity similar to a batter upon blending the organic materials together;
wherein the batter has a viscosity enabling retention within a heated iron apparatus and the batter is cooked in the iron forming equidistantly spaced indentions enabling uniform efficient removal of water in a freeze drying process.

2. The composition of claim 1, wherein the organ-based meat is animal liver including any one or more of beef liver, lamb liver, turkey liver, or chicken liver or a combination thereof

4. The composition of claim 1, wherein the organ-based meat is heart, kidney, or brain or a combination thereof.

5. The composition of claim 1, wherein a binder may be added including any one of flour or a combination of more than one flour type.

6. The composition of claim 5, wherein the flour is arrowroot flour, potato flour, tapioca flour, or soy flour, or a combination thereof.

7. The composition of claim 1, wherein the iron is a commercial waffle iron.

8. The composition of claim 1, wherein the homogeneous mixture is created using a commercial blender apparatus.

9. The composition of claim 1, further including a ground animal muscle meat like ground beef, ground chicken, ground turkey, ground lamb, or a combination thereof.

10. A method for preparing a dog treat composition for consumption, the dog treat composition including at least one organ-based animal meat, a binder, and a percentage of liquid to enable creation of a homogeneous mixture with a viscosity similar to a batter upon blending the organic materials together including;
(a) chopping, pulverizing, or otherwise reducing the meat to a pulp;
(b) adding the meat pulp, and a percentage of liquid to a blender apparatus;
(c) blending the mixture together to form a homogeneous batter;
(d) filling a waffle iron form with the homogeneous batter;
(e) cooking the homogeneous batter in the waffle iron form for a time period at a preset temperature;
(f) removing the cooked waffle-formed product from the waffle iron and allowing it to cool;
(g) placing the cooked waffle formed product into a freeze dryer apparatus; and
(h) freeze drying the cooked waffle formed product to reduce moisture to 10 percent or below.

11. The method of claim 10, wherein in (a) the organ-based animal meat is an organic lamb liver, an organic chicken liver, an organic turkey liver, or a combination thereof

12. The method of claim 10, wherein in (a) the organ-based animal meat is heart, kidney, or brain or a combination thereof

13. The method of claim 10, wherein in (b) a binder is introduced to the batter including flour or a combination of more than one flour.

14. The method of claim 13, wherein the flour is arrowroot flour, potato flour, tapioca flour, or soy flour, or a combination thereof.

15. The method of claim 10, wherein in (b) the percentage of meat pulp is within a range of 85-95 percent of total volume, the percentage of liquid is 5 to 15 percent of the total volume.

16. The method of claim 10, wherein in (d) filling the waffle iron form with the batter is automated by machine process.

17. The method of claim 10, wherein in (e) the cooking time is about 5 minutes at 355 to 375 degrees Fahrenheit.

18. The method of claim 10, Wherein in (e) the amount of batter poured into a waffle form is about one-half of a cup of batter.

19. The method of claim 10, wherein in (f) the waffle form is about 3 ½ inches long, about 2 ½ inches wide, and about ⅝ inches deep.

20. The method of claim 10, wherein in (h) the waffle form is reduced in moisture to 1 to 5 percent by volume.
